(19) United States
(12) Patent Application Publication
(10) Pub. No.: US 2002/0164987 A1
(43) Pub. Date: Nov. 7, 2002

(54) Method and apparatus for device location sensitive data routing

(76) Inventors: Germano Caronni, Mountain View, CA (US); Geoffrey Baehr, Menlo Park, CA (US)

Correspondence Address: COUDERT BROTHERS LLP, 333 SOUTH HOPE STREET, 23RD FLOOR, LOS ANGELES, CA, 90071, US

(21) Appl. No.: 09/737,193

(22) Filed: Dec. 13, 2000

(51) Int. Cl. H04Q 7/20

(52) U.S. Cl. 455/445; 455/456

(57) ABSTRACT

The present invention provides a method and apparatus for device location sensitive data routing. In one embodiment of the present invention, a signal from a portable, electronic device identifies a user. In this embodiment, a sensor detects the signal and relays the identification information along with information about electronic communications devices available at the location to a routing device. The routing device reroutes electronic communications to the physical location of the user. In one embodiment, the signal is a radio emanation. In another embodiment, the signal is an infrared emanation. In yet another embodiment, the signal is transmitted over a connection line which couples the portable, electronic device to the sensor. In one embodiment, phone calls are rerouted to a phone located near the portable, electronic device. In another embodiment, e-mail messages are rerouted to a general purpose computer located near the portable, electronic device. In one embodiment, a cellular phone is attached to a non-wireless phone line. In one embodiment, the user configures the routing device to perform an action when the user's location becomes known to the routing device. In another embodiment, the user configures the routing device to perform an action when the user's location becomes unknown to the routing device. In one embodiment, the user configures the routing device to send an e-mail. In another embodiment, the user configures the routing device to update a web page.

### BACKGROUND OF THE INVENTION

1. Field of the Invention

The present invention relates to the field of electronic communications, and in particular to a method and apparatus for device location sensitive data routing.

Sun, Sun Microsystems, the Sun logo, Solaris and all Java-based trademarks and logos are trademarks or registered trademarks of Sun Microsystems, Inc. in the United States and other countries. All SPARC trademarks are used under license and are trademarks of SPARC International, Inc. in the United States and other countries. Products bearing SPARC trademarks are based upon an architecture developed by Sun Microsystems, Inc.

2. Background Art

Electronic communications are routed with the intention that they reach the same physical location of the intended recipient. Some intended recipients are mobile. Thus, it is difficult to route communications to the physical location of the recipient. Portable communications devices attempt to reduce or eliminate this problem. However, use of portable communications devices is expensive and sometimes unavailable. This problem can be better understood by a review of electronic communications.

### Electronic Communications

In electronic communications, one entity attempts to establish a connection to another entity for the purpose of one-way or two-way data transfers via an electronic connection. Common examples of electronic communications include e-mail messages, computer chat, paging and phone calls. The success of attempts at electronic communication depend upon routing the communication to the physical location of the recipient. For example, to complete a phone call to a person, that person must be physically present to answer the phone when the phone rings.

Mobile users increase the difficulty in correctly routing electronic communication attempts. When a person leaves home, typically, a call placed to the home phone number will fail to reach that person.

### Routing to Mobile Users

One prior art solution involves the use of mobile communications devices. Electronic communications which are routed to a mobile communications device are successfully completed whenever the mobile communications device is with the intended recipient. For example, phone calls, pages and e-mail are routed to a cellular phone which the intended recipient keeps in close proximity. However, the use of such mobile communications devices is expensive. Additionally, mobile communications devices fail to function properly in certain locations.

Another prior art solution involves rerouting electronic communications. A person uses a forwarding device to reroute electronic communications originally sent to one device so that they are instead sent to another device. For example, if a user is going on vacation and will not be able to access messages sent to a primary address, the user configures a program to forward all e-mail messages which were sent to the primary e-mail address to a secondary e-mail address the user can access while on vacation. In another example, a user leaving home to visit another person's house sets a device to forward calls which are made to the user's home phone number to the other person's home phone number.

In this method, the user must configure the rerouting mechanism whenever the user changes locations. This is time consuming. Additionally, the user risks mis-configuring the forwarding device. A mis-configuration could lead to electronic communications being lost or routed to unacceptable locations.

One prior art solution involves rerouting phone calls and computer settings to the location of an active badge of a user. However, this system requires special purpose hardware, and the active badge must be carried by the user at all times. Additionally, the method fails to forward calls or data when a mobile user moves from a first location where a first instance of the system is installed to a second location where a second instance of the system is installed the system.

### PDAs

A PDA is a small computer-like device, usually no larger than the palm of a human hand, which typically has a base housing with an input mechanism mounted on its topside, and a miniature display screen for output. FIG. 1 is an illustration of one embodiment of a personal digital assistant. The PDA (100) shown in FIG. 1 is manufactured by 3Com and is called a Palm Pilot™. However, it will be apparent to one with ordinary skill in the art that the present invention can be used with any suitable word-processing software application on any suitable small device computer system. The PDA has a base housing (160) with input mechanisms mounted on its topside, and a miniature display screen (110) for output. The base housing of the PDA contains a small microprocessor, data storage and memory areas, a storage battery, and other various miniature electronic components. The electronic components and other features vary depending on the model, make, and manufacturer of the PDA. The PDA is activated and de-activated by accessing the power button (150).

PDA output may take the form of either graphic and/or textual images presented to users on the miniature display screen, or may be presented to users in the form of sound. Additionally, some PDAs can package information for output through cable or wireless networks. Thus, data is transmitted to a general purpose computer. Likewise, data transfers from general purpose computers to PDAs via the same mechanism.

The input mechanism may be, for example, a miniature keyboard (not shown). Alternatively, the miniature display screen may act as both an input and output mechanism. When used as an input mechanism, the user inputs the data via a pen-like stylus or other writing implement (not shown) directly on the display screen. This could take the form of handwriting, or highlighting certain specific areas on the display screen such as buttons, icons, or captions. With reference to FIG. 1, the bottom portion (120) of the display screen is where the user would input using the pen-like stylus. Additional mechanisms for user input include a scroll button (130) and an application button (140).

Conventional PDAs also contain an operating system, which is different from ones available for a general purpose desktop computer. PDAs also contain pre-loaded programs, such as word processing, spreadsheet, e-mail, and other related applications. The increasing popularity of PDAs stem from their relatively low cost and extreme portability compared to, for example, much larger general purpose desktop or laptop computers. Their popularity also stems from the fact that they can communicate with most popular desktop applications like spreadsheet programs, word processing programs and e-mail. Thus, transfer of data between PDAs and general purpose desktop computers is convenient and useful. Many users find that for simple computing tasks during trips and other periods of being away from their larger computers, PDAs suffice, and the computing power of even a compact notebook computer is not necessary.

As such, users often take PDAs on trips and find it convenient to re-route communications to their PDAs. This rerouting is disadvantageous, however, for the reasons described above, namely, it is tedious to continually reroute communications to the PDA from multiple potential sources where messages are received (i.e., home and work). Additionally, there is the risk of misconfiguration and the associated loss of messages. PDAs coupled to wireless modems also incur expensive wireless communications charges.

### SUMMARY OF THE INVENTION

The present invention provides a method and apparatus for device location sensitive data routing. In one embodiment of the present invention, communications to a mobile user are automatically rerouted to stationary electronic devices at the user's physical location. In this embodiment, a signal sensing device receives a signal from a portable, electronic device which travels with the mobile user. Once the signal sensing device determines the mobile user is present, it notifies a routing device. The routing device automatically reroutes the mobile user's communications (e.g., phone calls and e-mail messages) to the mobile user's new location.

In one embodiment of the present invention, a signal from a portable, electronic device identifies a user. In this embodiment, a sensor detects the signal and relays the identification information along with information about electronic communications devices available at the location to a routing device. The routing device reroutes electronic communications to the physical location of the user.

In one embodiment, the sensor is coupled to a general purpose computer. In one embodiment, the identification information is relayed to the routing device via a phone system. In another embodiment, the identification information is relayed to the routing device via e-mail. In other embodiments, the identification information is relayed to the routing device via other electronic communications methods.

In one embodiment, the portable, electronic device is a cellular phone. In another embodiment, the portable, electronic device is a PDA. In one embodiment, the signal is a radio emanation. In another embodiment, the signal is an infrared emanation. In yet another embodiment, the signal is transmitted over a connection line which couples the portable, electronic device to the sensor. In one embodiment, the signal is a mobile identifier signal of a cellular phone which is transmitted over a cellular phone control channel.

In one embodiment, phone calls are rerouted to a phone located near the portable, electronic device. In another embodiment, e-mail messages are rerouted to a general purpose computer located near the portable, electronic device.

In one embodiment, a cellular phone connects to a non-wireless phone line. In this embodiment, the cell phone communicates with a base station which is attached to the non-wireless line. Thus, calls to the cellular phone are routed to the cell phone via the non-wireless line and wireless charges are avoided. In one embodiment, the user is able to configure the routing device. In one embodiment, the user configures the routing device to perform an action when the user's location becomes known to the routing device. In another embodiment, the user configures the routing device to perform an action when the user's location becomes unknown to the routing device. In one embodiment, the user configures the routing device to send an e-mail. In another embodiment, the user configures the routing device to update a web page. In yet another embodiment, the user configures the routing device to turn on or off a household appliance. In still another embodiment, the user configures the routing device to transmit stored data to the user's location. In other embodiments, the user configures the routing device to control any of a number of electronic devices. In other embodiments, the user configures the routing device to perform any programmable behavior.

### BRIEF DESCRIPTION OF THE DRAWINGS

These and other features, aspects and advantages of the present invention will become better understood with regard to the following description, appended claims and accompanying drawings where:

FIG. 1 is a block diagram of a personal digital assistant.

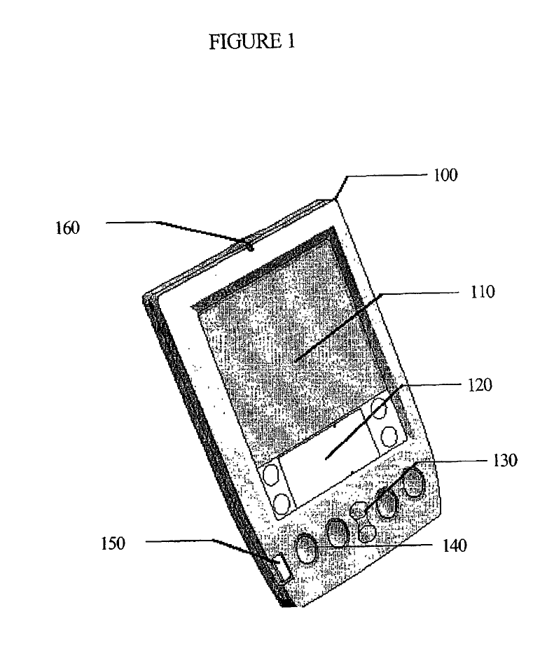

FIG. 2 is a flow diagram of the process of device location sensitive data routing in accordance with one embodiment of the present invention.

FIG. 3 is a flow diagram of the process of relaying identification information to a routing device in accordance with one embodiment of the present invention.

FIG. 4 is a flow diagram of the process of sensing the signal from a portable, electronic device in accordance with one embodiment of the present invention.

FIG. 5 is a flow diagram of the process of sensing the signal from a portable, electronic device in accordance with one embodiment of the present invention.

FIG. 6 is a flow diagram of the process of sensing the signal from a portable, electronic device in accordance with one embodiment of the present invention.

FIG. 7 is a flow diagram of the process of routing a phone call in accordance with one embodiment of the present invention.

FIG. 8 is a flow diagram of the process of routing an e-mail message in accordance with one embodiment of the present invention.

FIG. 9 is a flow diagram of the behavior of a routing device in accordance with one embodiment of the present invention.

FIG. 10 is a block diagram of a general purpose computer.

### DETAILED DESCRIPTION OF THE INVENTION

The invention is a method and apparatus for device location sensitive data routing. In the following description, numerous specific details are set forth to provide a more thorough description of embodiments of the invention. It is apparent, however, to one skilled in the art, that the invention may be practiced without these specific details. In other instances, well known features have not been described in detail so as not to obscure the invention.

### Device Location Sensitive Data Routing

In one embodiment of the present invention, communications to a mobile user are automatically rerouted to stationary electronic devices at the user's physical location. In this embodiment, a signal sensing device receives a signal from a portable, electronic device which travels with the mobile user. In one embodiment, the portable, electronic device is a cellular phone. In another embodiment, the portable, electronic device is a PDA. Other embodiments use other types of portable, electronic devices.

Once the signal sensing device determines the mobile user is present, it notifies a routing device. The routing device automatically reroutes the mobile user's communications (e.g., phone calls and e-mail messages) to the mobile user's new location. Thus, instead of manually forwarding calls from a home phone to a friend's phone, a mobile user's calls are automatically forwarded as soon as the mobile user arrives at the friend's home.

In one embodiment of the present invention, a signal from a portable, electronic device identifies a user. In this embodiment, a sensor detects the signal and relays the identification information along with information about electronic communications devices available at the location to a routing device. The routing device reroutes electronic communications to the physical location of the user.

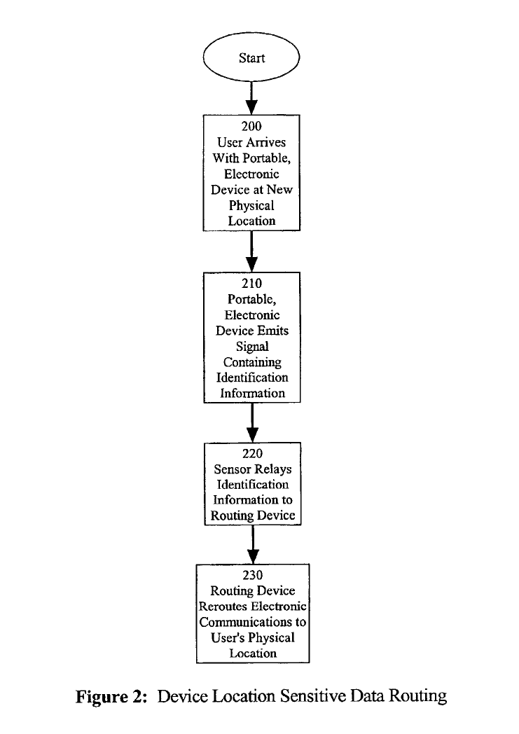

FIG. 2 illustrates the process of device location sensitive data routing in accordance with one embodiment of the present invention. At step 200, a user arrives with a portable, electronic device at a new physical location. At step 210, the portable, electronic device emits a signal containing identification information. At step 220, a sensor relays the identification information to a routing device. At step 230, the routing device reroutes electronic communications intended for the user to the user's physical location.

### Relaying to Routing Device

In one embodiment, the sensor is coupled to a general purpose computer. In one embodiment, the identification information is relayed to the routing device via a phone system. In another embodiment, the identification information is relayed to the routing device via e-mail. In other embodiments, the identification information is relayed to the routing device via other electronic communications methods.

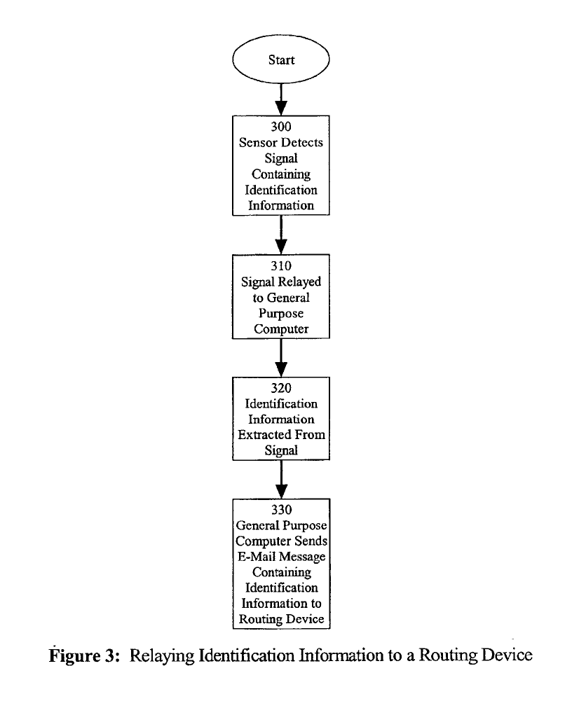

FIG. 3 illustrates the process of relaying identification information to a routing device in accordance with one embodiment of the present invention. At step 300, a sensor detects a signal containing identification information. At step 310, the signal is relayed to a general purpose computer. At step 320, the identification information is extracted from the signal. At step 330, the general purpose computer sends an e-mail message containing the identification information to a routing device.

### Portable, Electronic Device and Signal

In one embodiment, the portable, electronic device is a cellular phone. In another embodiment, the portable, electronic device is a PDA. In one embodiment, the signal is a radio emanation. In another embodiment, the signal is an infrared emanation. In yet another embodiment, the signal is transmitted over a connection line which couples the portable, electronic device to the sensor. In one embodiment, the signal is a mobile identifier signal of a cellular phone which is transmitted over a cellular phone control channel.

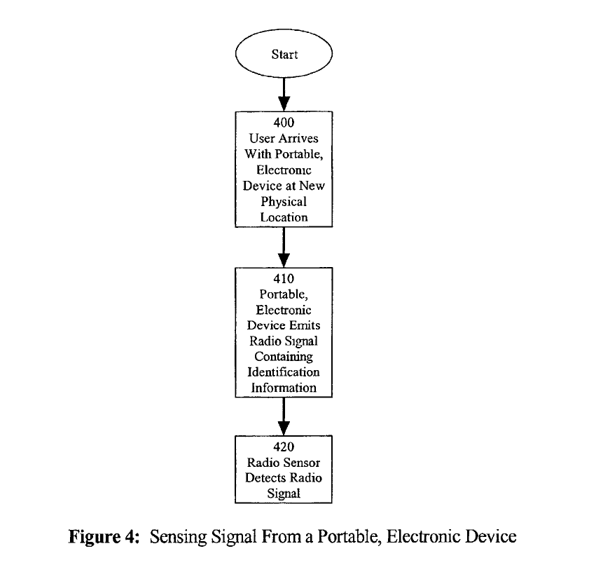

FIG. 4 illustrates the process of sensing the signal form a portable, electronic device in accordance with one embodiment of the present invention. At step 400, a user arrives with a portable, electronic device at a new physical location. At step 410, the portable, electronic device emits a radio signal containing identification information. At step 420, a radio sensor detects the radio signal.

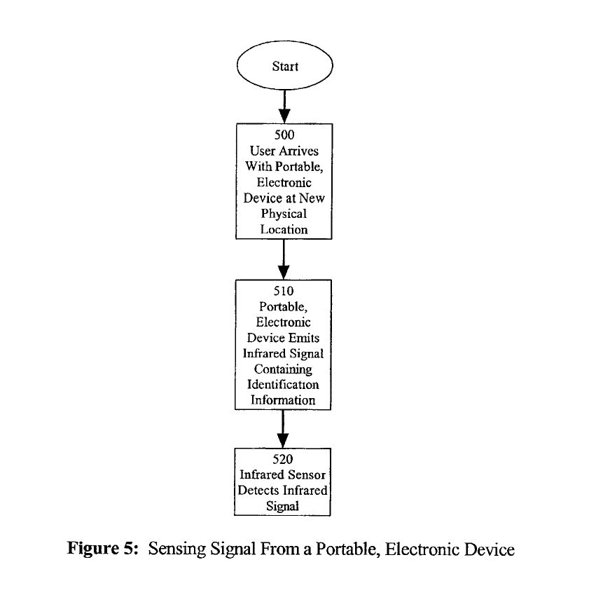

FIG. 5 illustrates the process of sensing the signal form a portable, electronic device in accordance with one embodiment of the present invention. At step 500, a user arrives with a PDA at a new physical location. At step 510, the PDA emits an infrared signal containing identification information. At step 520, an infrared sensor detects the infrared signal.

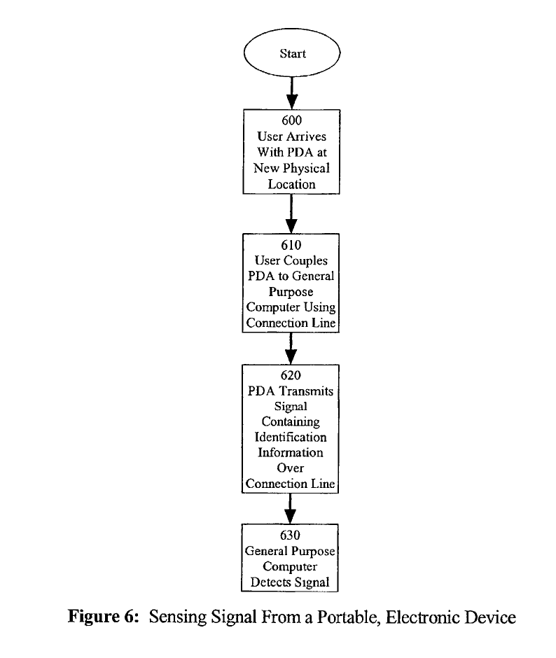

FIG. 6 illustrates the process of sensing the signal form a portable, electronic device in accordance with one embodiment of the present invention. At step 600, a user arrives with a PDA at a new physical location. At step 610, the user couples the PDA to a general purpose computer using a connection line. At step 620, the PDA transmits a signal containing identification information over the connection line. At step 630, the general purpose computer detects the signal.

### Rerouting

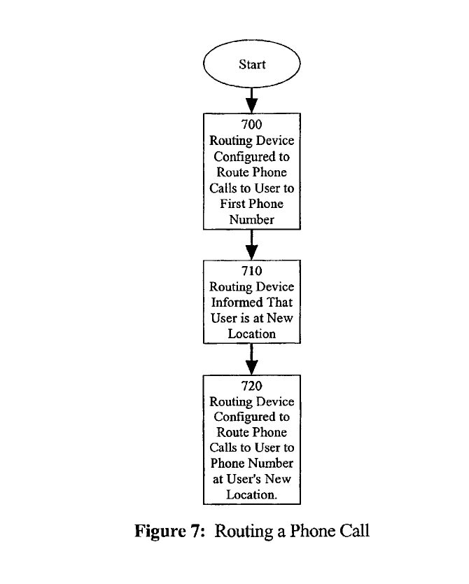

In one embodiment, phone calls are rerouted to a phone located near the portable, electronic device. FIG. 7 illustrates the process of routing a phone call in accordance with one embodiment of the present invention. At step 700, a routing device is configured to route phone calls to a user to a first phone number. At step 710, the routing device is informed that the user is at a new location. At step 720, the routing device is configured to route phone calls to the user to a phone number at the user's new location. Thus, a user avoids wireless phone charges by having all calls placed to the user's cellular phone rerouted to a phone at the user's location.

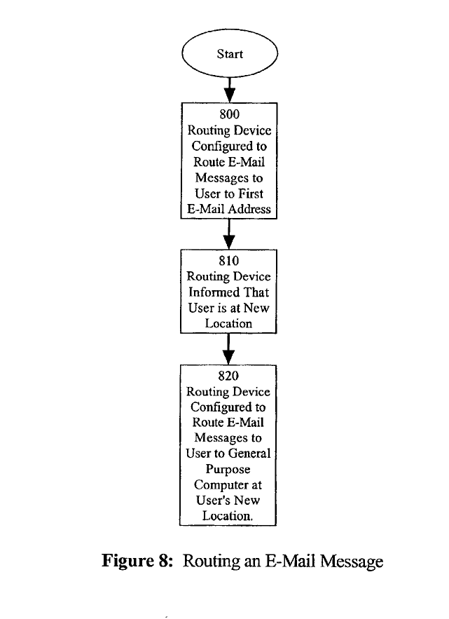

In another embodiment, e-mail messages are rerouted to a general purpose computer located near the portable, electronic device. FIG. 8 illustrates the process of routing an e-mail message in accordance with one embodiment of the present invention. At step 800, a routing device is configured to route e-mail messages to a user to a first e-mail address. At step 810, the routing device is informed that the user is at a new location. At step 820, the routing device is configured to route e-mail messages to the user to a general purpose computer at the user's new location.

In one embodiment, a cellular phone connects to a non-wireless phone line. In this embodiment, the cell phone communicates with a base station which is attached to the non-wireless line. Thus, calls to the cellular phone are routed to the cell phone via the non-wireless line. The user speaks into the cellular phone as usual. However, the communication is transmitted via the non-wireless line. Thus, the user avoids charges associated with wireless communications.

In one embodiment, the user is able to configure the routing device. In one embodiment, the user configures the routing device to perform an action when the user's location becomes known to the routing device. In another embodiment, the user configures the routing device to perform an action when the user's location becomes unknown to the routing device. In one embodiment, the user configures the routing device to send an e-mail. In another embodiment, the user configures the routing device to update a web page.

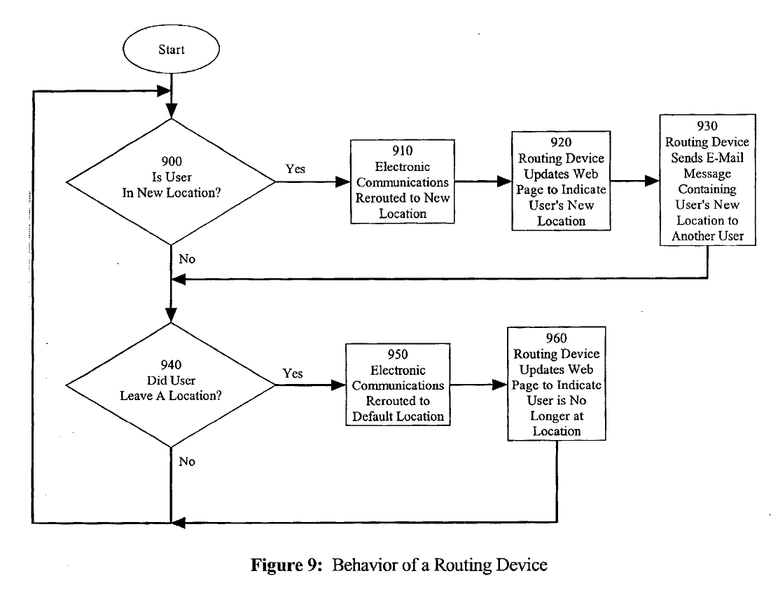

FIG. 9 illustrates the behavior of a routing device in accordance with one embodiment of the present invention. At step 900, it is determined whether a user is in a new location. If the user is in a new location, at step 910, electronic communications are rerouted to the new location. At step 920, the routing device updates a web page to indicate the user's new location. At step 930, the routing device sends an e-mail message containing the user's new location to another user and the process continues at step 940. If at step 900 the user is not in a new location, the process continues at step 940.

At step 940, it is determined whether a user has left a location. If the user has left the location, at step 950, electronic communications are rerouted to a default location. At step 960, the routing device updates a web page to indicate the user is no longer at the location and the process continues at step 900. If the user has not left the location, the process continues at step 900.

In another embodiment, the user configures the routing device to turn a home appliance on or off. For example, a user may desire to return from work to a cool home in a hot region, but is not willing to incur the expense of having the air conditioner running all day. Additionally, this user may have an unpredictable schedule, making the use of a timer on the air conditioner ineffective. This user configures the routing device so that when the user leaves work, the routing device switches on the air conditioner.

In another embodiment, the user configures the routing device to transmit stored data to the user's location. For example, a user may configure the routing device to send a copy of an important file to the user's new location. Thus, the user has access to the file when the user arrives at a new location. In other embodiments, the user configures the routing device to control any of a number of electronic devices. In other embodiments, the user configures the routing device to perform any programmable behavior.

### Embodiment of Computer Execution Environment (Hardware)

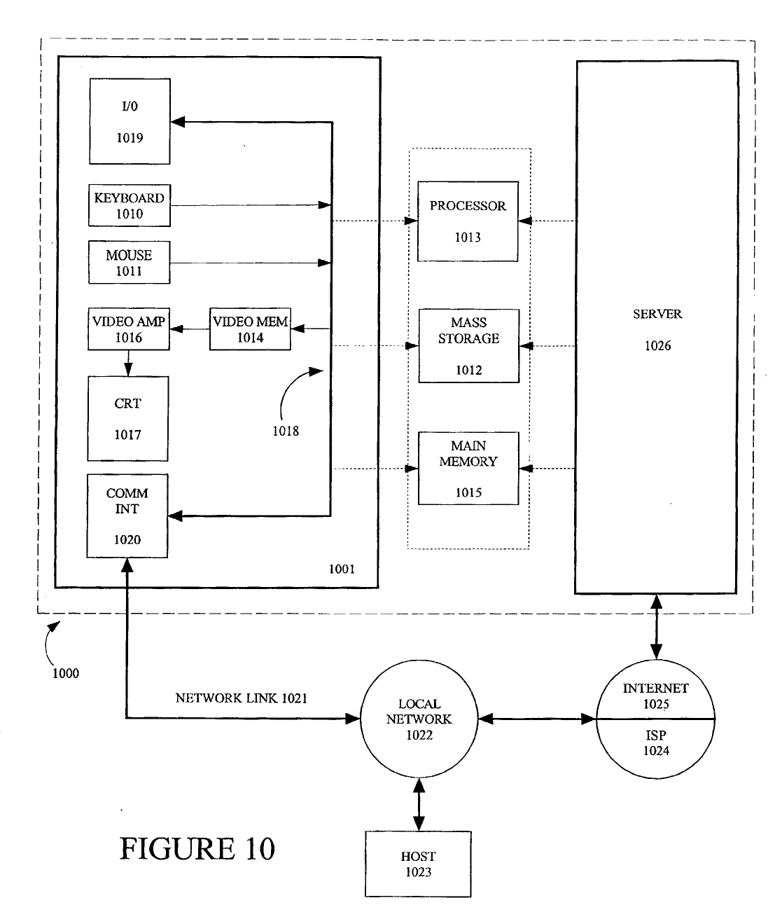

One or more embodiments of the present invention makes recording and/or viewing devices using a general purpose computing device as shown in FIG. 10. A keyboard, 1010 and mouse 1011 are coupled to a system bus 1018. The keyboard and mouse are for introducing user input to the computer system and communicating that user input to central processing unit (CPU) 1013. Other suitable input devices may be used in addition to, or in place of, the mouse 1011 and keyboard 1010. I/O (input/output) unit 1019 coupled to bi-directional system bus 1018 represents such I/O elements as a printer, A/V (audio/video) I/O, etc.

Computer 1001 may include a communication interface 1020 coupled to bus 1018. Communication interface 1020 provides a two-way data communication coupling via a network link 1021 to a local network 1022. For example, if communication interface 1020 is an integrated services digital network (ISDN) card or a modem, communication interface 1020 provides a data communication connection to the corresponding type of telephone line, which comprises part of network link 1021. If communication interface 1020 is a local area network (LAN) card, communication interface 1020 provides a data communication connection via network link 1021 to a compatible LAN. Wireless links are also possible. In any such implementation, communication interface 1020 sends and receives electrical, electromagnetic or optical signals which carry digital data streams representing various types of information.

Network link 1021 typically provides data communication through one or more networks to other data devices. For example, network link 1021 may provide a connection through local network 1022 to local server computer 1023 or to data equipment operated by ISP 1024. ISP 1024 in turn provides data communication services through the world wide packet data communication network now commonly referred to as the “Internet” 1025. Local network 1022 and Internet 1025 both use electrical, electromagnetic or optical signals which carry digital data streams. The signals through the various networks and the signals on network link 1021 and through communication interface 1020, which carry the digital data to and from computer 1000, are exemplary forms of carrier waves transporting the information.

Processor 1013 may reside wholly on client computer 1001 or wholly on server 1026 or processor 1013 may have its computational power distributed between computer 1001 and server 1026. Server 1026 symbolically is represented in FIG. 10 as one unit, but server 1026 can also be distributed between multiple “tiers”. In one embodiment, server 1026 comprises a middle and back tier where application logic executes in the middle tier and persistent data is obtained in the back tier. In the case where processor 1013 resides wholly on server 1026, the results of the computations performed by processor 1013 are transmitted to computer 1001 via Internet 1025, Internet Service Provider (ISP) 1024, local network 1022 and communication interface 1020. In this way, computer 1001 is able to display the results of the computation to a user in the form of output.

Computer 1001 includes a video memory 1014, main memory 1015 and mass storage 1012, all coupled to bi-directional system bus 1018 along with keyboard 1010, mouse 1011 and processor 1013. As with processor 1013, in various computing environments, main memory 1015 and mass storage 1012, can reside wholly on server 1026 or computer 1001, or they may be distributed between the two. Examples of systems where processor 1013, main memory 1015, and mass storage 1012 are distributed between computer 1001 and server 1026 include the thin-client computing architecture developed by Sun Microsystems, Inc., the palm pilot computing device and other personal digital assistants, Internet ready cellular phones and other Internet computing devices, and in platform independent computing environments, such as those which utilize the Java technologies also developed by Sun Microsystems, Inc.

The mass storage 1012 may include both fixed and removable media, such as magnetic, optical or magnetic optical storage systems or any other available mass storage technology. Bus 1018 may contain, for example, thirty-two address lines for addressing video memory 1014 or main memory 1015. The system bus 1018 also includes, for example, a 32-bit data bus for transferring data between and among the components, such as processor 1013, main memory 1015, video memory 1014 and mass storage 1012. Alternatively, multiplex data/address lines may be used instead of separate data and address lines.

In one embodiment of the invention, the processor 1013 is a SPARC microprocessor from Sun Microsystems, Inc., a microprocessor manufactured by Motorola, such as the 680×0 processor, or a microprocessor manufactured by Intel, such as the 80×86 or Pentium processor. However, any other suitable microprocessor or microcomputer may be utilized. Main memory 1015 is comprised of dynamic random access memory (DRAM). Video memory 1014 is a dual-ported video random access memory. One port of the video memory 1014 is coupled to video amplifier 1016. The video amplifier 1016 is used to drive the cathode ray tube (CRT) raster monitor 1017. Video amplifier 1016 is well known in the art and maybe implemented by any suitable apparatus. This circuitry converts pixel data stored in video memory 1014 to a raster signal suitable for use by monitor 1017. Monitor 1017 is a type of monitor suitable for displaying graphic images.

Computer 1001 can send messages and receive data, including program code, through the network(s), network link 1021, and communication interface 1020. In the Internet example, remote server computer 1026 might transmit a requested code for an application program through Internet 1025, ISP 1024, local network 1022 and communication interface 1020. The received code may be executed by processor 1013 as it is received, and/or stored in mass storage 1012, or other non-volatile storage for later execution. In this manner, computer 1000 may obtain application code in the form of a carrier wave. Alternatively, remote server computer 1026 may execute applications using processor 1013, and utilize mass storage 1012, and/or video memory 1015. The results of the execution at server 1026 are then transmitted through Internet 1025, ISP 1024, local network 1022 and communication interface 1020. In this example, computer 1001 performs only input and output functions.

Application code may be embodied in any form of computer program product. A computer program product comprises a medium configured to store or transport computer readable code, or in which computer readable code may be embedded. Some examples of computer program products are CD-ROM disks, ROM cards, floppy disks, magnetic tapes, computer hard drives, servers on a network, and carrier waves.

The computer systems described above are for purposes of example only. An embodiment of the invention may be implemented in any type of computer system or programming or processing environment.

Thus, a method and apparatus for device sensitive data routing is described in conjunction with one or more specific embodiments. The invention is defined by the following claims and their full scope and equivalents.

1. A method for device location sensitive data routing comprising:
detecting a signal at a location wherein said signal emanates from a portable, electronic device wherein said signal contains a user identifier wherein said user identifier identifies a user;
transmitting to a routing device said user identifier and a list of one or more communications devices wherein said communications devices are at said location; and
rerouting one or more electronic communications to said communications devices wherein said electronic communications are intended for said user.

2. The method of claim 1 wherein said step of transmitting comprises:
transmitting via a phone system.

3. The method of claim 1 wherein said step of transmitting comprises:
transmitting via e-mail.

4. The method of claim 1 wherein said portable, electronic device is a cellular phone.

5. The method of claim 1 wherein said portable, electronic device is a PDA.

6. The method of claim 1 wherein said signal is a radio signal.

7. The method of claim 1 wherein said signal is an infrared signal.

8. The method of claim 1 wherein said signal emanates via a connection line wherein said connection line couples said portable, electronic device and sensor.

9. The method of claim 1 wherein said electronic communications are phone calls.

10. The method of claim 1 wherein said electronic communications are e-mail messages.

11. The method of claim 1 further comprising:
coupling a cellular phone to a non-wireless phone line.

12. The method of claim 1 further comprising:
configuring said routing device to perform an action, if a condition is met.

13. The method of claim 12 wherein said condition is said user first appears at said location.

14. The method of claim 12 wherein said condition is said user leaves said location.

15. The method of claim 12 wherein said action is updating a web page.

16. The method of claim 12 wherein said action is sending an e-mail message.

17. A device location sensitive data router comprising:
a detector configured to detect a signal at a location wherein said signal emanates from a portable, electronic device wherein said signal contains a user-identifier wherein said user identifier identifies a user;
a transmitter configured to transmit said user identifier and a list of one or more communications devices wherein said communications devices are at said location; and
a routing device configured to receive said list and said user identifier wherein said routing device is further configured to reroute one or more electronic communications to said communications devices wherein said electronic communications are intended for said user.

18. The device location sensitive data router of claim 17 wherein said transmitter is further configured to transmit via a phone system.

19. The device location sensitive data router of claim 17 wherein said transmitter is further configured to transmit via e-mail.

20. The device location sensitive data router of claim 17 wherein said portable, electronic device is a cellular phone.

21. The device location sensitive data router of claim 17 wherein said portable, electronic device is a PDA.

22. The device location sensitive data router of claim 17 wherein said signal is a radio signal.

23. The device location sensitive data router of claim 17 wherein said signal is an infrared signal.

24. The device location sensitive data router of claim 17 wherein said signal emanates via a connection line wherein said connection line couples said portable, electronic device and sensor.

25. The device location sensitive data router of claim 17 wherein said electronic communications are phone calls.

26. The device location sensitive data router of claim 17 wherein said electronic communications are e-mail messages.

27. The device location sensitive data router of claim 17 further comprising:
a cellular phone coupled to a non-wireless phone line.

28. The device location sensitive data router of claim 17 wherein said routing device is further configured to perform an action, if a condition is met.

29. The device location sensitive data router of claim 28 wherein said condition is said user first appears at said location.

30. The device location sensitive data router of claim 28 wherein said condition is said user leaves said location.

31. The device location sensitive data router of claim 28 wherein said action is updating a web page.

32. The device location sensitive data router of claim 28 wherein said action is sending an e-mail message.

33. A computer program product comprising:
a computer usable medium having computer readable program code embodied therein configured to route data, said computer program product comprising:
computer readable code configured to cause a computer to detect a signal at a location wherein said signal emanates from a portable, electronic device wherein said signal contains a user identifier wherein said user identifier identifies a user;
computer readable code configured to cause a computer to transmit said user identifier and a list of one or more communications devices wherein said communications devices are at said location to a routing device; and
computer readable code configured to cause a computer to reroute one or more electronic communications to said communications devices wherein said electronic communications are intended for said user.

34. The computer program product of claim 33 wherein said computer readable code configured to cause a computer to transmit comprises: computer readable code configured to cause a computer to transmit via a phone system.

35. The computer program product of claim 33 wherein said computer readable code configured to cause a computer to transmit comprises:
computer readable code configured to cause a computer to transmit via e-mail.

36. The computer program product of claim 33 wherein said portable, electronic device is a cellular phone.

37. The computer program product of claim 33 wherein said portable, electronic device is a PDA.

38. The computer program product of claim 33 wherein said signal is a radio signal.

39. The computer program product of claim 33 wherein said signal is an infrared signal.

40. The computer program product of claim 33 wherein said signal emanates via a connection line wherein said connection line couples said portable, electronic device and sensor.

41. The computer program product of claim 33 wherein said electronic communications are phone calls.

42. The computer program product of claim 33 wherein said electronic communications are e-mail messages.

43. The computer program product of claim 33 further comprising:
computer readable code configured to cause a computer to couple a cellular phone to a non-wireless phone line.

44. The computer program product of claim 33 further comprising:
computer readable code configured to cause a computer to perform an action, if a condition is met.

45. The computer program product of claim 44 wherein said condition is said user first appears at said location.

46. The computer program product of claim 44 wherein said condition is said user leaves said location.

47. The computer program product of claim 44 wherein said action is updating a web page.

48. The computer program product of claim 44 wherein said action is sending an e-mail message.
